(19) United States
(12) Patent Application Publication
(10) Pub. No.: US 2016/0301844 A1
(43) Pub. Date: Oct. 13, 2016

(54) SYSTEM, METHOD, AND DEVICE FOR ENHANCED IMAGING DEVICE

(71) Applicant: Rememdia LC

(72) Inventor: Fraser Smith, Salt Lake City, UT (US)

(21) Appl. No.: 14/684,247

(22) Filed: Apr. 10, 2015

(51) Int. Cl. H04N 5/238; H04N 5/232

(52) U.S. Cl. CPC H04N 5/238; H04N 5/23293

(57) ABSTRACT

A system for enhanced detection of luminescent materials in an environment occupied by an amount of light having a portable electronic device having a display screen. The system also includes an image sensor disposed about the portable electronic device coupled to a processor and a computer readable storage medium having a library of wavelength information corresponding to a first wavelength of light at which a substance luminesces when subject to a second wavelength of light. The computer readable media includes executable instructions configured to receive data from the image sensor and convert said data into a first image of a target area within the field-of-view of the image sensor. The processor is further configured to eliminate from the first image wavelength of light data received from the image sensor not corresponding to the second wavelength of light.

### FIELD OF THE TECHNOLOGY

The present technology relates to improved devices, methods, and systems for enhanced imaging. More particularly, the present technology relates to tools for enhancing imaging of certain objects in a naturally lit environment.

### BACKGROUND OF THE TECHNOLOGY AND RELATED ART

The detection of evidence has historically been a combined process of art and science. One conventional method of obtaining, for example, fingerprint evidence is the careful lifting of fingerprints by applying a fine dust to the surface of a fresh print and then transferring the dust pattern onto a second surface. Fingerprint dusting powders were initially selected for their color contrasting qualities. Extremely fine fluorescent dusting powders were also used to visualize minute etchings of a surface caused by the breakdown of amino acids contained in fingerprint oils. The fluorescent dusting powder adheres to the etchings and reveals the fingerprint pattern upon illumination by ultraviolet radiation. Other substances, such as blood, saliva, urine, or semen, are more easily detected where visible stains exist. However, often such revealing evidence is concealed from ordinary inspection via cleansing agents or even the passage of time. In more recent years, supplemental ultraviolet light has been used by forensic specialists to aid in the viewing of otherwise “invisible evidence.” Ultraviolet (“UV”) radiation is light that is just beyond the visible spectrum. Where visible light has a wavelength ranging from about 400 nm to about 750 nm, UV radiation has a shorter wavelength and ranges from about 10 nm to about 400 nm. Although the unaided human eye cannot discern UV radiation, its presence can be shown by use of either UV-sensitive media or the resultant fluorescence of a UV-sensitive material. The sun emits ultraviolet A (“UVA”) radiation, ultraviolet B (“UVB”) radiation, and ultraviolet C (“UVC”) radiation. UVA radiation has longer wavelengths than UVB radiation or UVC radiation. UVA radiation, for instance, has wavelengths from about 400 nm to 315 nm. UVB radiation, on the other hand, has wavelengths from about 315 nm to 280 nm, while UVC radiation has wavelengths less than about 280 nm. Most of the ultraviolet radiation that passes through the Earth's atmosphere is UVA radiation.

Photography (particularly forensic photography) is a complex field in which the final products are produced from photo-optical information about subject scenes, as sensed by photographic media (film, photo-sensitive computer chips, etc.) with the aid of a camera. It has been recognized that a rendered reproduction whose brightness or reflectance ratios objectively matches the scene luminance ratios is not a very “good” photograph. Rather, it is desirable to “render” measured scene luminance to an artistically and/or functionally preferred reproduction. A combination of techniques involving the camera, the scene lighting, the film, the film developing, and the film printing give the photographer a great deal of control over how a scene is rendered to produce a desired photographic reproduction. With the development of electronic communication, digital devices having a digital processing function, such as digital cameras, mobile phones, game machines, and micro cameras, have been rapidly spread. Most of the digital devices include an image sensor required for taking an image. The image sensor converts an image input as light from outside into an electrical signal and transmits the electrical signal to a digital processing device. Non-limiting examples of an image sensor include a charge coupled device (CCD) and/or a complementary metal oxide semiconductor (CMOS). The CCD image sensor includes a photodiode, a CCD, and a signal detection circuit, which are formed over a P-type impurity layer. The photodiode serves to convert light incident from outside into an electric charge, the CCD serves to transmit the electric charge to the signal detection circuit, and the signal detection circuit serves to convert the electric charge into a voltage. The CMOS image sensor includes a CMOS transistor configured to convert an input image into an electrical signal. Both image sensors are known in the art.

Conventional use of image sensors to detect the presence of substances that luminesce when exposed to certain wavelengths of light must take place in an area devoid of background light that “washes out” the luminescence of the substance. For example, forensic analysis of luminescing compounds is optimally performed in the dark, where only the objects that luminesce are visible to the human eye. It is desirable to have systems, methods and devices that eliminate the need for performing said investigations in the dark.

### SUMMARY OF THE INVENTION

In light of the problems and deficiencies inherent in the prior art, the present invention seeks to overcome these by providing methods, devices, and systems for enhanced imaging. In accordance with one aspect of the technology, a system for enhanced detection of luminescent materials in an environment occupied by an amount of light is disclosed. The system comprises a portable electronic device having a display screen and an image sensor disposed about the portable electronic device coupled to a processor. A computer readable storage medium having a library of wavelength information corresponding to a first wavelength of light at which a substance luminesces when subject to a second wavelength of light is provided. The processor comprises computer readable media with executable instructions configured to receive data from the image sensor and convert said data into a first image of a target area within the field-of-view of the image sensor. In one aspect, the image comprises a plurality of wavelengths of light greater than about 400 nanometers. In addition, the computer readable media of the processor is configured to eliminate from the first image, wavelength of light data received from the image sensor not corresponding to the second wavelength of light.

In another aspect of the technology, a method implementable on a portable electronic display device having an image sensor is disclosed. The electronic device has a processor configured with executable instructions for receiving data from the image sensor and converting said data into a first image of a target area within the field-of-view of the image sensor, the image comprising a plurality of wavelengths of light greater than about 400 nanometers. The method further comprises eliminating from the first image, wavelength of light data received from the image sensor not corresponding to a predefined range of wavelengths of light, said predefined range of wavelengths of light corresponding to a first range of wavelengths of light at which an object luminesces when subject to a second range of wavelengths of light. It also comprises displaying the first image on the display device.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology they are, therefore, not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is a diagram of an imaging system in accordance with one aspect of the technology;

FIG. 2 is a front view of a display in accordance with another aspect of the technology; and

FIG. 3 is a front view of a display in accordance with one aspect of the technology.

### DETAILED DESCRIPTION OF EXEMPLARY ASPECTS OF THE TECHNOLOGY

The following detailed description of exemplary aspects of the technology makes reference to the accompanying drawings, which form a part hereof and in which are shown, by way of illustration, exemplary aspects in which the technology may be practiced. While these exemplary aspects are described in sufficient detail to enable those skilled in the art to practice the technology, it should be understood that other aspects may be realized and that various changes to the technology may be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology, to set forth the best mode of operation of the technology, and to sufficiently enable one skilled in the art to practice the technology. Accordingly, the scope of the present technology is to be defined solely by the appended claims. The following detailed description and exemplary aspects of the technology will be best understood by reference to the accompanying drawings, wherein the elements and features of the technology are designated by numerals throughout.

An initial overview of technology is provided below and specific technology is then described in further detail. This initial summary is intended to aid readers in understanding the technology more quickly, but is not intended to identify key or essential features of the technology, nor is it intended to limit the scope of the claimed subject matter.

The detection of substances such as blood and semen that may be unobservable (or difficult to observe) to the naked eye is an important tool in crime scene investigation. In addition, proper hygiene has long been identified as important to the control of disease, unwanted odors from pets, and/or other aesthetic reasons. A social aversion has developed to the presence of urine, semen, etc. in hotel rooms, rental units, used cars, used homes, and the like due, in part, to efforts to educate persons about public health concerns and proper hygiene. Aspects of the technology described herein are intended to take advantage of the social aversion and/or evidentiary value associated with the presence of semen, urine, blood, or other substances. Particularly, aspects of the technology are intended to enhance the ability of persons to detect luminescent substances that are difficult to observe using existing methods and systems that rely on a dark environment or an environment flooded with an extraordinary amount of UV radiation to view those substances.

There are many types of materials that “luminesce” when exposed to UV light. These materials tend to have rigid molecular structures that contain delocalized electrons (ones that are not associated with any specific atom within the molecule). For example, when a UV light wave hits an object containing substances known as phosphors, those phosphors will naturally luminesce or “glow.” This luminescence is created by the way these phosphors use the energy from UV light. When a photon from UV light hits the phosphorous material, it causes the electrons to become excited and stray farther from the nucleus than they normally would. When the electron falls back to its normal state it, some of the energy is lost. When the UV light wave is reflected back to human eyes, it has less energy and therefore a shorter wavelength. This wavelength is in the visible spectrum.

Some common examples of these types of materials include white paper made after 1950 (when manufactures began adding fluorescent compounds to paper, making it appear whiter), petroleum jelly, tonic water (due to the presence of quinine), and the edges of US currency (an added security feature to help prevent counterfeiting), among many others. Some common vitamins that fluoresce include A, and B vitamins, niacin, thiamine, and riboflavin. Antifreeze, tooth whiteners, and chlorophyll also luminesce when exposed to UV light. With respect to aspects of the current invention, urine, semen, and other human residue luminesces when exposed to UV light. Phosphors, such as those contained in urine, luminesce in the presence of oxygen, with or without UV light, but the light imparts additional energy that make the luminescence more apparent. As used herein, the term “luminescence” pertains to fluorescence, phosphorescence, and chemiluminescence, as well as to selective absorbance of predefined wavelength regions of the electromagnetic spectrum, such as infrared (IR) and near infrared (NIR). A luminescent composition or substance is one which emits light, which is not derived from the temperature of the emitting body.

As noted above, different substances luminesce when subjected to or excited by different wavelengths of light. For example, under standard conditions of visible light illumination (400-700 nm), untreated dry semen has a broad band of emission from 300 to 480 nm, just below the range of visibility to the naked eye in some instances. Long wavelength UVA (around 350 nm) illumination of untreated dry semen produces a narrower band of emissions centered near the blue visible region (around 420 to 450 nm). In another non-limiting example, illuminating dried semen with a band of visible light at 450 nm produces visible fluorescence in a broad region with a maximum around 520 nm.

Dried saliva is virtually colorless and difficult to detect by the naked eye. It is believed that saliva stain is detectable by the naked eye when exposed to UV light around 350 nm where it produces a band of emissions similar to that of semen. Excitation of saliva at wavelengths in a short UV range (260 to 270 nm) is believed to be able to result in higher intensity luminescence. It is also believed that an excitation wavelength ranging from approximately 440 to 460 nm with the use of a 555 nm interference filter (a filter that uses an interference effect to “transmit” a 555 nm wavelength of light and “reflect” other wavelengths) results in viewable saliva stain. Other combinations of excitation wavelengths and/or interference filters are contemplated herein though interference filters are not required.

Urine stains are hard to be seen because of the nature of urine and the fact that urine will become diluted on fabric surfaces. In fact, urine stains luminesce when exposed to UV light, but the color of the stain may vary in the presence of abnormal substances, such as glycosuria. In one non-limiting example, it is believed that urine luminesces at a wavelength of between 420 and 450 nm and is detectable by human eyes when subjected to a 400 nm wavelength of excitation energy.

In a preferred aspect of the technology, naturally occurring UV wavelengths of light from the sun are relied upon to provide the necessary radiation to view enhanced images described herein. However, in another aspect of the technology described herein, a supplemental UV light is employed that propagates light at a wavelength ranging from approximately 315 to 400 nanometers. Other UV lights emit light at wavelengths of light in the mid (290-315 nm) or far (190-290 nm) UV fields but are less desirable (but still useable herein) because they may cause skin or eye irritation.

The present invention involves advantageous modifications to imaging systems. Generally speaking, image sensors (including CCD and CMOS devices) include thousands, or even millions, of light-receiving photosites. The energy of the light incident to each photosite is converted into a signal charge which is output from the sensor. This charge, however, only represents the intensity of the light that was incident on a particular photosite for the time the shutter is open. It does not produce color images. To produce color images, in general, most image sensors employ a filtering scheme to look at the incoming light in its three primary colors (e.g., typically red, green and blue (RGB). Once all three primary colors have been measured, they can be combined to create the full spectrum color image. There are several ways to capture the intensity of each of the primary colors of the light. However, the method applicable to the present invention generally involves using a single image sensor having a 2-D array of photosites each of which is dedicated to a particular primary color and interpolating the color for each pixel of the image using the intensity of the colors detected at the photosites in a neighborhood around the pixel location. This method has the advantages of requiring just one sensor and measuring all the color information at the same time. As a result, the digital camera can be made smaller and less expensive than, for example, multiple image sensor cameras. To dedicate each photosite to a particular primary color, appropriate filters are placed between the photosite and the incoming light, which only let light of the desired wavelengths through to the photosite. In one aspect of the technology, these filters are integrated into the image sensor itself.

The most common pattern for a color filter is the Bayer filter pattern. This pattern alternates a row of blue and green filters with a row of red and green filters. The effective result is twice as many green filters as there are red or blue filters. This is because humans are more sensitive to green. The raw output of a Bayer filtered image sensor is an array of red, green and blue intensity values. These raw outputs are subjected to a demosaicing algorithm that converts the separate color values into an equal-sized array of true colors. In one aspect, this is accomplished by averaging the intensity values for each missing primary color from the closest surrounding photosites. While a single image sensor is referenced herein, other arrangements, such as a three-CCD camera, may be used. A three-CCD camera is a camera whose imaging system uses three separate charge-coupled devices, each one taking a separate measurement of the primary colors, red, green, or blue light. Light coming into the lens is split by a trichroic prism assembly, which directs the appropriate wavelength ranges of light to their respective CCDs. Compared to cameras with only one CCD, three-CCD cameras generally provide improved image quality through enhanced resolution and lower noise.

While existing single image sensors are well suited for general photography and video recording purposes, some objects that luminesce when subjected to UV wavelengths of light are “washed out” during the capture of standard RGB intensity values. That is, objects that luminesce in the visible (or in some cases IR) spectrum when subjected to UV radiation, or other excitation light energy values, compete with the other objects that appear in the visible spectrum due to regular absorption and/or reflectance of light energy. The amount of UV radiation produced by the sun varies greatly based on the time of day and time of year. One non-limiting example includes a scenario where a CCD camera is used to observe a target area within a sunlit room. The incident power density in midday summer sun is typically 0.6 mW/(nm m2) at 295 nm, 74 mW/(nm m2) at 305 nm, and 478 mW/(nm m2) at 325 nm. The varying amounts of UV radiation at different wavelengths of light cause urine, for example, to luminesce at a wavelength of 440 nm. Objects that radiate at a wavelength of about 440 nm may appear blue to the naked eye. However, the abundance of natural sunlight in the visible spectrum (400 nm to 700 nm) does not permit the human eye to observe the luminescence of the urine which is why current techniques require forensic UV analysis in a dark room. While a high-intensity pulse of UV radiation may permit a user to observe the luminescence in a partially sunlit area, such a pulse may result in overexposure to UV radiation and also requires additional equipment and materials to detect the subject substance (e.g., urine, vomit, bed bugs, fluorescent drugs, etc.).

It is intended that the present technology be operable with different types of functional attachments or components with the end result of improved systems, devices, and methods for enhanced imaging of luminescent materials and a previously lit environment. Bearing that in mind, aspects of the technology can be broadly described as a system for enhanced detection of luminescent materials in an environment occupied by an amount of visible light, comprising a portable electronic device having a display screen and an image sensor disposed about the portable electronic device coupled to a processor. A computer readable storage medium is provided having a library of wavelength information corresponding to a first wavelength of light at which a particular substance, or family of substances, luminesces when subject to a second wavelength of light. The processor also comprises computer readable media configured to receive data from the image sensor and convert said data into a first image of a target area within the field-of-view of the image sensor, the image comprising a plurality of wavelengths of light greater than about 400 nm. The computer readable media of the processor is further configured to eliminate from the first image, wavelength of light data received from the image sensor that does not correspond to the second wavelength of light. In this manner, a user may selectively observe materials that luminesce when subjected to the UV radiation naturally occurring in sunlight without a supplemental source of UV light.

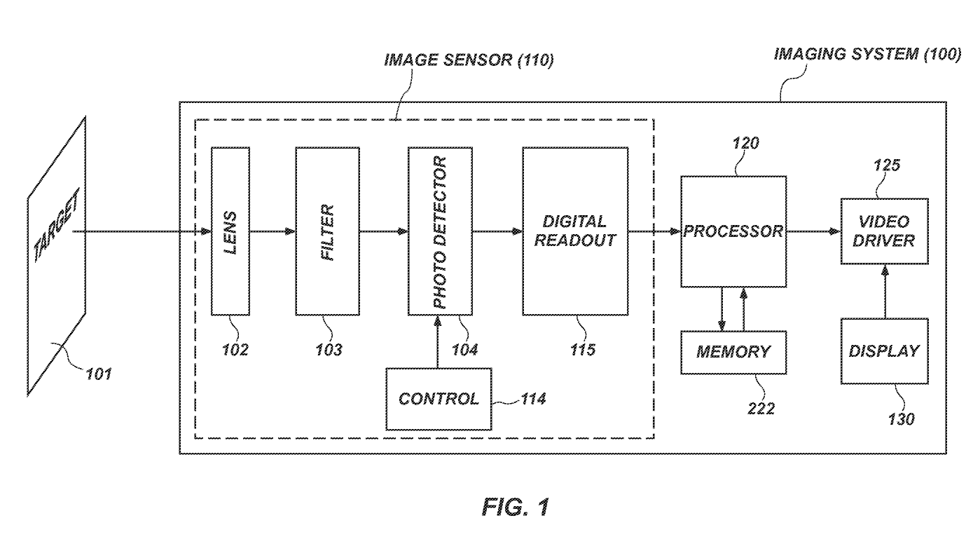

With reference now to FIG. 1, a block diagram depiction of an example UV-based imaging system 100 is provided in accordance with one aspect of the technology. The imaging system 100 renders a displayed image for the user to determine the presence of otherwise difficult-to-detect objects present in a naturally or artificially lit region 101. System 100 comprises an image sensor 110 that comprises a lens 102 that provides an aperture for system 100 and focuses incoming light, so that system 100 operates on reflected light emanating from the target area 101 collected by lens 102 and sensed by a single common 2-D photodetector array 104 that comprises a plurality of pixels. In accordance with one aspect, system 100 is generally a passive imaging system as it does not require a separate light source, such as a light source that provides UV light. In another aspect, a separate UV light source is utilized in the event the lit region 101 is lighted by a source of light lacking UV frequencies of radiation or an adequate intensity of UV radiation.

A filter 103 is shown that is optically aligned and matched (i.e., has about the same size) with respective ones of the plurality of photodetector pixels in 2-D photodetector array 104 (e.g., a CCD or CMOS device). The filter 103 can be a band reject, band pass, low pass, or long pass, and can be embodied as a polarizing filter. Although shown as an internal filter, filter 103 can be an external filter (i.e., positioned in front of lens 102) or may not be present at all. 2-D photodetector array 104 transduces light from the UV band, and generally also the visible (color) band, and optionally the NIR band, into electrical signals. The 2-D photodetector array 104 can comprise, for example, a plurality of CCD elements, or a plurality of CMOS sensing elements such as photodiodes, phototransistors, or avalanche diodes. Night (or low light) operation can be provided by a 2-D photodetector array 104 comprising electron multiplied CCD, or a light source that provides UV light, though operation in a naturally lit environment is most likely. The filter array 103 shown can comprise a plurality of filter elements, including a UV band pass and at least one other reference band pass that excludes UV. As described above, respective ones of the filter elements of filter 103 are optically aligned and substantially matched (i.e., have about the same size) with respective ones of the pixels in 2-D photodetector array 104.

A control mechanism 114 is operative with the 2-D photodetector array 104 that comprises control electronics. The control mechanism 114 generates the control signals (e.g., control voltages) to control the operation of the 2-D photodetector array 104. When the 2-D photodetector array 104 comprises CMOS elements, control mechanism 114 can generally be formed on the same substrate having a semiconductor surface (i.e., a silicon chip) that generates the on-chip control signals (e.g., voltage pulses) used to control the operation of the 2-D photodetector array 104. The voltage outputs provided by 2-D photodetector array 104 are read out by the digital read out 115 shown in FIG. 1 that generally comprises an analog to digital (A/D) converter. 2-D photodetector array 104 provides a plurality of outputs.

A processor 120, such as a digital signal processor or microcomputer, is coupled to receive and process the plurality of electrical signals provided by digital read out 115. The processor 120 provides data processing (i.e., image processing) as described herein. An output of processor 120 is coupled to a video driver 125 which is coupled to a video display 130, such as a video screen (e.g., monitor) on a portable electronic device, that provides a viewable image.

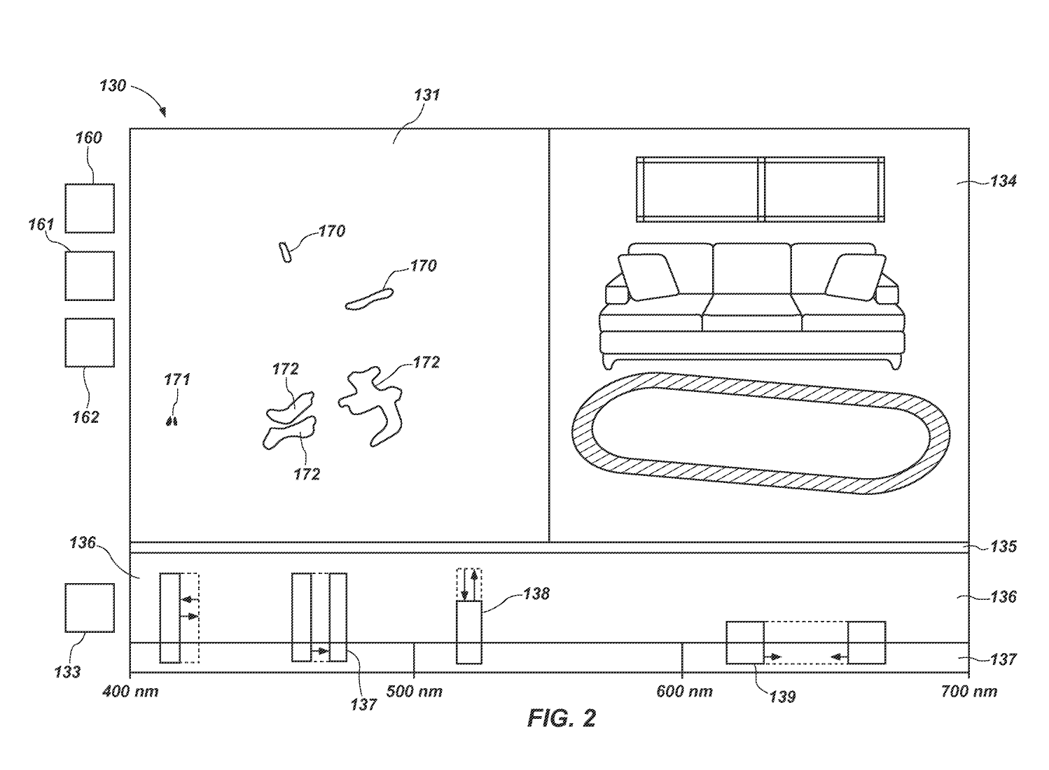

Referencing FIGS. 1 and 2, in accordance with one aspect of the technology, the system 100 comprises a portable electronic device having a display screen 130 and an image sensor disposed about the portable electronic device 100 operatively coupled to the processor 120. The processor 120 comprises a computer readable storage medium 222 having a library of wavelength information corresponding to a first wavelength of light at which a substance luminesces when subject to a second wavelength of light. For example, urine may luminesce at 420 nm when subjected to wavelengths of light ranging from 350 to 400 nm. The processor 120 also comprises computer readable medium configured to receive data from the image sensor 110 and convert said data into a first image 131 of a target area 101 within the field-of-view of the image sensor 110. The image comprises a plurality of wavelengths of light greater than about 400 nm (i.e., those visible to the human eye). Importantly, processor 120 is configured with a filter capable of eliminating from the first image 131, all wavelengths of light data received from the image sensor 110 that do not correspond to the second wavelength of light. A band-stop filter or band-rejection filter is a filter that passes most frequencies unaltered, but attenuates those in a specific range to very low levels. A notch filter is a band-stop filter with a narrow stopband (high Q factor). Narrow notch filters are used in Raman spectroscopy, live sound reproduction and in instrument amplifiers to reduce or prevent audio feedback, while having little noticeable effect on the rest of the frequency spectrum.

In one non-limiting example, keeping with the urine example, a band-stop filter (or notch filter) associated with the processor 120 eliminates all wavelengths of light data that is not 420 nm. That is, it precludes wavelengths of light from being transmitted to the video driver 125 that are not 420 nm. Advantageously, the radiation that is naturally occurring from the sunlight that “washes out” the luminescence occurring from the irradiated urine example discussed above is eliminated from the image 131 shown on the display 130.

In one aspect of the technology, the processor 120 is further configured to convert data received from the image sensor 110 into a second image 134 of the target area 101 that comprises all wavelengths of light captured by the image sensor 110 between about 400 nm and 700 nm (i.e., in the visible range). The second image 134 represents a “normal” camera (or imaging system) view of the target area 101 as the image substantially appears to the naked eye without use of the imaging system. The “normal” image is not processed through a notch filter (described in greater detail below). In this manner, the user may hold the portable electronic device and view the “normal” field-of-view of the target area 101 and simultaneously view the enhanced image 131 in a side-by-side fashion. This will assist the user in locating areas of interest within the target area 101.

In one aspect of the technology, the first wavelength of light is less than about 400 nanometers and the second wavelength of light is greater than about 400 nanometers, though other frequencies are contemplated herein as suits a particular purpose. In addition, the processor 120 is configured to increase the intensity of the second wavelength of light displayed on the display screen 130. In this manner, any compounds of interest (e.g., urine) appear brighter on the display 130. This feature compensates for low luminescence from a lack of the compound or a lack of UV radiation present in the target area 101.

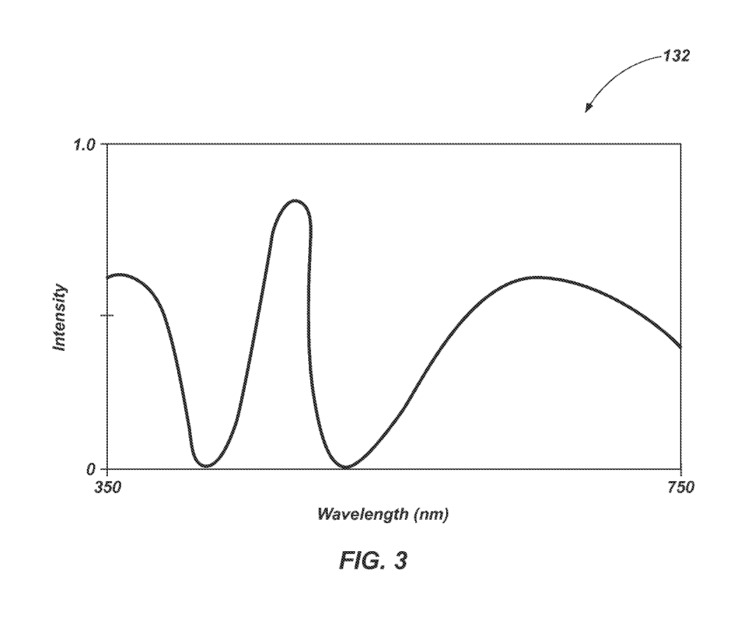

With reference now to FIGS. 1 through 3 generally, in accordance with one aspect of the technology, the display screen 130 comprises a touch screen, for example, having available a graphical display 132 of a range of wavelengths of light in the target area 101 available for display as well as those wavelengths of light outside of the visible range (e.g., less than 400 nm and/or greater than 700 nm). By touching tab 133, a user may show display 132. A sensor is incorporated into or otherwise operative with the portable electronic device that detects when the intensity of UV radiation present in the target area 101 as well as other wavelengths of radiation and works with the imaging system 100 to produce display 132. In one aspect, an automated alert is provided on the display 130 if the sensor detecting UV radiation detects that a suboptimal range and/or intensity of UV radiation is present to effectively image luminescent materials. Display 131, 132, and 134 depict dynamic images; meaning that as the field-of-view of the image sensor 110 changes so does the display. In this manner, the user may position the imaging system 100 in a room with respect to a window, for example, to locate a field-of-view for optimizing available UV radiation in a room and/or may traverse a room or inside of a car in an effort to locate subject substances.

In accordance with one aspect of the technology, the graphical display 132 and screen 130 are configured such that a user of the system 100 may select an initial wavelength of light to be displayed in the first image 131 by touching the graphical display 132 in area 135, though in one aspect the initial wavelength may be selected by touching in area 136. A range of wavelengths (e.g., 420-430 nm) or a single wavelength (e.g., 425 nm) may be selected as suits a particular purpose. Those wavelengths of light not found within the initial wavelength of light are eliminated from the first image 131 with use of the notch filter. The graphical display 132 is configured to increase or decrease the range of the wavelength of light to be displayed by touching the graphical display 132 with a contact tool (e.g., a finger, pen, or other device) in region 136 and moving the contact tool about the display screen 130. For example, a user may touch the display screen 130 in region 135 above the area proximate to the 400 nm designation resulting in an initial selection of 415 to 425 nm. The user may place his or her fingers on the range and increase or decrease the range by sliding the fingers to increase or decrease the size of the rectangle illustrating the chosen range. The graphical display 132 and screen 130 are also configured such that the user of the system 100 may adjust the entire range values (the selected notch range, e.g., 20 nm) of the selected range of wavelengths of light to be displayed by touching the graphical display 132 with a contact tool in region 137 and moving the contact tool about the display screen 130 to slide the desired range upward or downward along the scale. That is, a selected notch filter of 10 nm, for example, is moveable about the visible scale to encompass other 10 nm ranges (e.g., 420 to 430 nm, 440 to 450 nm, or 445 to 455 nm, etc.). For example, a notch filter range of 20 nm (shown at 139) covering approximately 615 to 635 nm may be moved to a 20 nm range covering 655 to 675 nm.

In like manner, the intensity of any preselected range of values may be increased or decreased by touching the graphical display 132 with a contact tool in region 136 and moving the range upward or downward as shown at call-out numeral 138. While the range of frequencies available to display shown on FIG. 2 is limited to between 400 and 700 nm, it is understood that frequencies outside of this range are contemplated for use herein to enhance the imaging capability of objects that fluoresce outside of those ranges. That is, the 400 to 700 nm range shown in FIG. 2 is illustrative only of one aspect of the technology.

In one aspect of the technology, a plurality of tabs are provided on the graphical display 132 to permit the user to select a predetermined value of wavelengths of light to be shown in the first image 131. Those tabs are configured to display wavelengths of light corresponding to the luminescence of a particular substance. For example, tab 160 displays a wavelength of light associated with the luminescence of semen, tab 161 is associated with urine, and tab 162 with blood. The selection of any particular tab is not mutually exclusive with the selection of other tabs, meaning more than one tab may be selected during single viewing event such that more than one wavelength range of interest may be displayed on the image 131 at the same time. As respective tabs are selected, respective materials may appear on the display corresponding to a particular wavelength of light. For example, a user may select tab 161 and observe subject 170 representative of the presence of urine. A user may then select tab 160 and observe subject 171 representative of the presence of semen. A user may then also select tab 162 and observe subject 172 representative of blood.

Although a touch screen type display is discussed in detail herein, as well as the graphical layout of selectable inputs, this is not intended to be limiting in any way. Other types of display formats, types, etc., as well as other types of graphical user layouts and interfaces are contemplated herein.

In one aspect of the technology, the processor 120 is configured to create a composite image of both images 131 and 134 such that the luminescent objects are superimposed about image 134. In this manner, the user may view the luminescent objects within the same frame as the image 134. In this aspect, the coloring of the luminescent objects is artificially enhanced or changed in order to more clearly identify the object in the composite image. For example, subject 170 appears in the composite image as a bright yellow object, subject 172 appears in the composite image as red, and subject 171 appears in the composite image as bright white. While body fluid substances (e.g., urine, vomit, diarrhea, etc.) are specifically referenced herein, other objects or substances of interest that luminesce are contemplated herein, e.g., bed bugs, etc. (collectively referred to in general as “substances”). In addition, while reference is made herein to objects that luminesce in the visible spectrum, in another aspect of the technology, the processor 120 is configured with a notch filter adapted to produce images of substances that luminesce in the infrared spectrum. Those substances that luminesce in that spectrum are given a “false” color so that they appear in the visible spectrum in the display 130. In this manner, objects that luminesce over a large range of wavelengths are detectable.

The imaging system 100 may operate in conjunction with a server and includes data storage capabilities. The term “data storage” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The media content stored by the media storage module may be video content, audio content, image content, text content or another type of media content, particularly such as may be included in a review of an organization.

Example electronic devices described herein may include, but are not limited to, a desktop computer, a laptop, a tablet, a mobile device, a television, a cell phone, a smart phone, a hand held messaging device, a set-top box, a personal data assistant, an electronic book reader, heads up display (HUD) glasses, or any device with a display that may receive and present the media content. Users of the imaging system may be identified via various methods, such as a unique login and password, a unique authentication method, an Internet Protocol (IP) address of the user's computer, an HTTP (Hyper Text Transfer Protocol) cookie, a GPS (Global Positioning System) coordinate, or using similar identification methods. A user may have an account with a server, service or provider, which may optionally track use history, viewing history, store user preferences and profile information and so forth.

Various applications and/or other functionality may be executed in the imaging system 100 according to various aspects of the technology, which applications and/or functionality may be represented at least in part by the functionality of the system 100 described herein. Also, various image, temperature, time, and other data associated with imaging events may be stored that is accessible to the processor 120.

The devices describe herein may have addition access to I/O (input/output) devices that are usable by the imaging system 100. An example of an I/O device is the display screen 130 that is available to display output from the processor 120. Other known I/O devices may be used with the computing device as desired. Networking devices and similar communication devices may be included in the imaging system 100. The networking devices may be wired or wireless networking devices that connect to the internet, a LAN, WAN, or other computing network. The display 130 may comprise, for example, one or more devices such as cathode ray tubes (CRTs), liquid crystal display (LCD) screens, gas plasma based flat panel displays, LCD projectors, or other types of display devices, etc.

The programs employed by the processor 120 to enhance the images described herein may be executable on one or more computer readable media. The term “executable” may mean a program file that is in a form that may be executed by a processor. For example, a program in a higher level language may be compiled into machine code in a format that may be loaded into a random access portion of the memory device and executed by the processor, or source code may be loaded by another executable program and interpreted to generate instructions in a random access portion of the memory device to be executed by a processor. The executable program may be stored in any portion or component of the memory device. For example, the memory device may be random access memory (RAM), read only memory (ROM), flash memory, a solid state drive, memory card, a hard drive, optical disk, floppy disk, magnetic tape, or any other memory components.

In accordance with one aspect of the technology herein, a method implementable on a portable electronic display device having an image sensor and a processor configured with executable instructions is disclosed. The method comprises receiving data from the image sensor and converting said data into a first image of a target area within the field-of-view of the image sensor, the image comprising a plurality of wavelengths of light greater than about 400 nm. As noted in greater detail above, the method further comprises eliminating from the first image, wavelength of light data received from the image sensor that does not correspond to a predefined range of wavelengths of light. Said predefined range of wavelengths of light corresponds to a first range of wavelengths of light at which an object luminesces when subject to a second range of wavelengths of light. The method further comprises displaying the first image on the display device. In one aspect, the method comprises displaying a second image representative of a “normal” image as seen from existing cameras known in the art. Moreover, in other aspects, the method comprises selecting, increased, decreased, and/or amending the predefined wavelengths of light that will comprise the first image.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A system for enhanced detection of luminescent materials in an environment occupied by an amount of light, comprising:
a portable electronic device having a display screen;
an image sensor disposed about the portable electronic device coupled to a processor; and
wherein the processor comprises computer readable media with executable instructions configured to receive data from the image sensor and convert said data into a first image of a target area within the field-of-view of the image sensor, the image comprising a plurality of wavelengths of light greater than about 400 nanometers;
wherein the computer readable media of the processor is further configured to eliminate a first image wavelength of light data received from the image sensor not corresponding to a second wavelength of light.

2. The system of claim 1, wherein the processor is further configured to convert said data from the image sensor into a second image of the target area, the second image comprising all wavelengths of light captured by the image sensor greater than about 400 nanometers.

3. The system of claim 1, wherein the first wavelength of light is less than about 400 nanometers and the second wavelength of light is greater than about 400 nanometers.

4. The system of claim 1, wherein the processor is configured to increase the intensity of the second wavelength of light displayed on the display screen.

5. The system of claim 1, wherein the display screen comprises a touch screen comprising a graphical display of a range of wavelengths of light in the target area available for display, the graphical display and screen configured such that a user of the system may (i) select an initial wavelength of light to be displayed by touching the graphical display, (ii) increase the range of the wavelength of light to be displayed by touching the graphical display with a contact tool and moving the contact tool about the display screen in a first direction, and (iii) decrease the range of the wavelength of light to be displayed by touching the graphical display with the contact tool and moving the contact tool about the display screen in a direction opposite the first direction.

6. The system of claim 5, wherein the graphical display and screen are configured such that the user of the system may adjust the values of the selected range of wavelengths of light to be displayed by touching the graphical display with a contact tool in a predefined location on the screen and moving the contact tool laterally about the display screen.

7. The system of claim 6, wherein the graphical display and screen are configured such that the location on the graphical display configured to adjust the range of the wavelength of light is located apart from the location on the graphical display configured to adjust the values within a predetermined range.

8. The system of claim 3, wherein the graphical display is configured to permit a user to select a second wavelength of light based on a user-identified substance.

9. The system of claim 1, further comprising a sensor configured to detect the presence and intensity of wavelengths of light within the target area below about 400 nanometers.

10. The system of claim 9, further comprising a graphical display showing the presence and intensity of wavelengths of light within the target area below about 400 nanometers.

11. A system for enhanced detection of luminescent materials in an environment occupied by a pre-existing amount of sunlight, comprising:
a portable electronic device having a display screen;
an image sensor disposed about the portable electronic device coupled to a processor;
a computer readable storage medium having a library of wavelength information corresponding to a first range of wavelengths of light at which a substance luminesces when subject to a second range of wavelengths of light emanating from the sun;
wherein the processor comprises computer readable media configured to receive data from the image sensor and convert said data into a first image of a target area within the field-of-view of the image sensor, the image comprising a plurality of wavelengths of light greater than about 400 nanometers;
wherein the computer readable medium of the processor is further configured to eliminate from the first image wavelength of light data received from the image sensor not corresponding to the second range of wavelengths of light.

12. The system of claim 11, wherein the display screen comprises a touch screen comprising a graphical display of a range of wavelengths of light in the target area available for display, the graphical display and screen are configured such that a user of the system may select an initial range of the second wavelength of light to be displayed by touching the graphical display.

13. The system of claim 12, wherein the graphical display and screen are configured such that a user of the system may increase the range of the second wavelength of light to be displayed by touching the graphical display with a contact tool and moving the contact tool about the display screen in a first direction, and decrease the range of the second wavelength of light to be displayed by touching the graphical display with the contact tool and moving the contact tool about the display screen in a direction opposite the first direction.

14. The system of claim 11, wherein the processor is further configured to convert said data from the image sensor into a second image of the target area, the second image comprising all wavelengths of light captured by the image sensor greater than about 400 nanometers.

15. The system of claim 14, wherein the display screen comprises an area displaying the first image and an area displaying the second image.

16. The system of claim 15, wherein the display area of the first image and the display area of the second image are adjustable.

17. A method implementable on a portable electronic display device having an image sensor and a processor configured with executable instructions, the method comprising:
receiving data from the image sensor and converting said data into a first image of a target area within the field-of-view of the image sensor, the image comprising a plurality of wavelengths of light greater than about 400 nanometers; and
eliminating from the first image, wavelength of light data received from the image sensor not corresponding to a predefined range of wavelengths of light, said predefined range of wavelengths of light corresponding to a first range of wavelengths of light at which an object luminesces when subject to a second range of wavelengths of light;
displaying the first image on the display device.

18. The method of claim 17, further comprising the step of selecting the second range of wavelengths of light to be displayed.

19. The method of claim 18, further comprising increasing the second range of wavelengths of light to be displayed on the portable electronic device.

20. The method of claim 18, further comprising decreasing the second range of wavelengths of light to be displayed.

21. The method of claim 18, further comprising adjusting the intensity of the second range of wavelengths of light to be displayed.
